(19) United States
(12) Patent Application Publication
(10) Pub. No.: US 2024/0278657 A1
(43) Pub. Date: Aug. 22, 2024

(54) ELECTRONIC CONVERSION KIT FOR A MOTOR VEHICLE IN WHICH AN INTERNAL COMBUSTION ENGINE IS EXCHANGED FOR AN ELECTRIC TRACTION DRIVE HAVING AN ELECTRIC MOTOR, MOTOR VEHICLE HAVING THE CONVERSION KIT AND OPERATING METHOD FOR THE CONVERSION KIT

(71) Applicant: E-R3VOLT GMBH, Dachau (DE)

(72) Inventor: Ralf SCHOLLENBERGER, Aschheim (DE)

(21) Appl. No.: 18/292,730

(22) PCT Filed: Jul. 27, 2022
(86) PCT No.: PCT/EP2022/071030

§ 371 Date: Jan. 26, 2024

(30) Foreign Application Priority Data
Jul. 28, 2021 (DE) 10 2021 119 579.9

(51) Int. Cl. B60L 50/16

(52) U.S. Cl. CPC B60L 50/16; B60L 2200/46; B60L 2240/421

(57) ABSTRACT

An electronic conversion kit (24) for a motor vehicle (10), where an internal combustion engine (15) is exchanged for an electric traction drive (11) having an electric motor (12), where the conversion kit (24) includes a bus module (21) to couple an existing bus system (19) and/or existing control device (18) of the motor vehicle (10) on the one hand and a new bus system (17) and/or new control device (16) of the electric traction drive (11) on the other, and which provides a processor circuit to receive signals from the existing bus system (19) and/or existing control device (18) and/or new bus system (17) and/or new control device (16), to translate said signals by a signal conversion and to pass on said signals and/or to artificially generate missing signals from at least one assembly of an internal combustion engine (15) by means of restbus simulation.

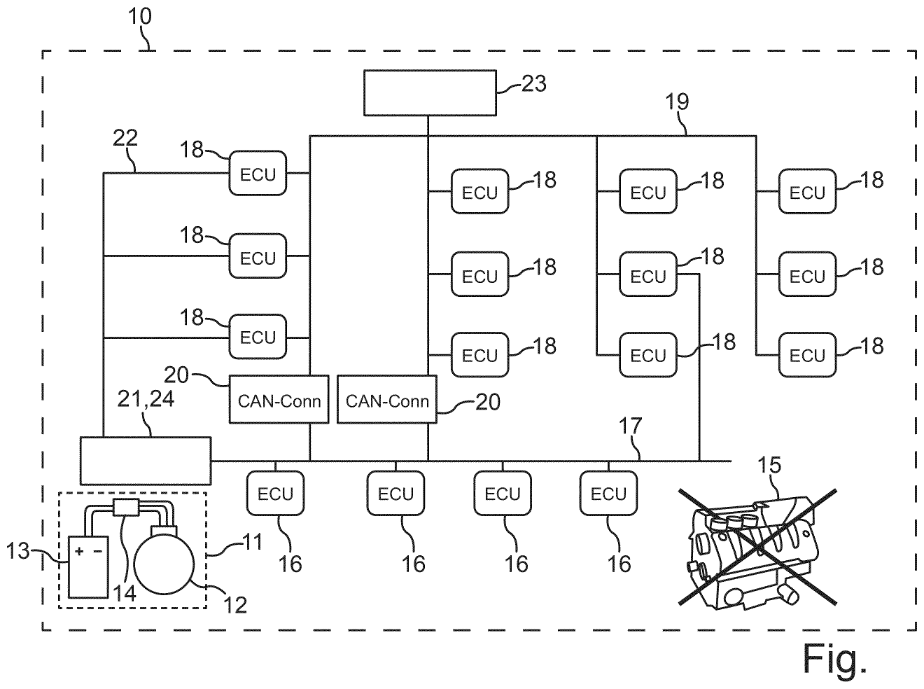

Electronic conversion kit for a motor vehicle, in which an internal combustion engine is exchanged for an electric traction drive having an electric motor, motor vehicle having the conversion kit and operating method for the conversion kit

The invention relates to an electronic conversion kit for a motor vehicle, in which an internal combustion engine is exchanged for an electric traction drive with electric motor. The invention also relates to an electrically driven motor vehicle with such a conversion kit and to an operating method for the conversion kit.

Up to now, cars (passenger cars) were developed, constructed and sold as combustion engine cars (gasoline engine/diesel engine cars), and they were operated until they could no longer be economically operated. The useful life of vehicles has been considerably extended in the last decades (according to study of the Institute CAR Duisburg: 25% of the vehicles in Germany are older than 15 years; the average age is at 9.6 years). Many of the today's vehicles are longer drivable from the technical status than a few years ago, the permanent durability or the rust protection has been greatly improved. Thus, body, chassis or attachment parts can be further used without problem.

A conversion of combustion engine cars to electric vehicles (EVs) currently occurs almost exclusively with older vehicles (before ca. year of manufacture 2005) without consideration of the existing electronics, especially the driver assistance systems (ADAS—Advanced Driver Assistance System). Here, it is a disadvantage that older vehicles have a lower expectable residual useful life upon regular use, and therefore the conversion would not be profitable anymore in many vehicles. The conversion of more modern vehicles is more profitable, but which comprise a data network with control devices for complex electronic vehicle functions, which are adapted to the characteristics of the internal combustion engine.

Therefore, the complexity of the electronic architecture of the basic vehicle, which makes an integration of new drive components technically expensive, is a disadvantage for a conversion to an electric traction drive in newer vehicles. This results in the fact that a conversion either entails the loss of many important ADAS/electronic modules or requires an expensive post-development of the control devices and interconnection logic. These costs and time expenditures prevented such reconstructions heretofore.

The invention is based on the object to convert a motor vehicle, which comprises an internal combustion engine, into a purely electrically driven motor vehicle (electric vehicle).

As the solution, the invention provides the subject matters of the independent claims. Advantageous developments of these solutions are described by the dependent claims, the following description as well as the figures.

As one aspect of the solution, the invention provides an electronic conversion kit for a motor vehicle. Therein, the invention assumes that an internal combustion engine is being exchanged or is already exchanged for an electric traction drive with electric motor in the motor vehicle and electronic functions of the motor vehicle are to be adapted to the converted traction drive, thus to a purely electric traction drive with at least one electric motor, by means of the conversion kit.

As the solution, the invention provides that the conversion kit includes at least one bus module, which is configured to couple at least one existing bus system and/or existing control device of the motor vehicle on the one hand and at least one new bus system and/or new control device of the electric traction drive on the other hand. By the at least one bus module, a processor circuit is hereto provided, which is configured to receive signals from the at least one existing bus system and/or existing control device and/or new bus system and/or new control device, to translate or convert these received signals by means of a predetermined signal conversion and to pass the respectively translated signal (to at least one existing control device and/or new control device and/or into at least one existing bus system and/or new bus system). In particular, signals from the existing part (existing bus system and/or existing control device) are translated into signals for the new part (new bus system and/or new control device) and/or signals from the new part are translated into signals for the existing part. In addition, signals of at least one missing or not present assembly of an internal combustion engine are artificially generated by means of a restbus simulation. Thus, a simulation of at least one assembly of an internal combustion engine occurs. In other words, an assembly, which signals a functionality for an internal combustion engine (e.g. rotational speed measurement for the internal combustion engine), is simulated. Such an assembly can also be a control device, e.g. an engine control device.

Here, the prefix “existing” is used for such vehicle components (e.g. bus system and/or control device), which were already present before the conversion also for the operation of the internal combustion engine. Here, the prefix “new” is used for such vehicle components (e.g. bus system and/or control device), which have been newly added to the purely electric traction drive (internal combustion engine is removed) by the conversion and are provided for the operation of the electric traction drive.

Generally, the said respective bus module can be configured as a control device (ECU—Electronic Control Unit) for connecting to a new bus system or as a bus gateway for connecting the at least one existing bus system and the at least one new bus system. A respective bus module can comprise at least one electrical bus terminal and/or at least one terminal for a connection cable to a control device (existing control device and/or new control device), to provide an electrical connection for a signal transfer or data transfer. The respective bus module can be provided e.g. for connection to a CAN bus (CAN—Controller Area Network), wherefore it is here also referred to as E—CAN module, wherein no restriction to the CAN bus is preferably understood hereby.

The conversion kit includes the processor circuit, which is provided by the at least one bus module. In case of a single bus module, it can be an integral processor circuit of the single bus module, or in case of multiple bus modules, a distributed circuit in the multiple bus modules, which collectively provide the functionality described here. The processor circuit is configured to perform the said signal conversion and the said restbus simulation. By the signal conversion, a communication or translation of signals between the at least one existing bus system and/or existing control device of the motor vehicle on the one hand and the at least one new bus system and/or new control device of the retrofitted electric traction drive on the other hand is performed, thus a signaling coupling. Signals required for the operation of the motor vehicle, which are missing due to a disassembled assembly of the internal combustion engine after conversion, are artificially generated by the restbus simulation e.g. by means of a simulation of this assembly.

The invention has the advantage that the further operation of vehicle functions can be ensured, which were adapted to the internal combustion engine on the part of the manufacturer and therefore require the presence and/or the operation of assemblies and/or control devices of the internal combustion engine. A particularly relevant case is the engine control device of an internal combustion engine: Now, it can be ensured that this control device further functions (if it remains in the motor vehicle) and/or the signals thereof are further present in an existing bus system (if it is disassembled from the motor vehicle). Such a control device can e.g. be a part of the component protection/cluster, which has to be further active in the motor vehicle and has to be active in an existing bus system (e.g. a CAN bus). For preventing malfunctions and/or error messages, the required input signals can now be generated at the engine control device and/or another existing control device.

The at least one bus module of the conversion kit can generate the preset signals based on a current drive situation and input them e.g. into the engine control device if it is still present and expects signals of an assembly of the internal combustion engine. For example, the respective bus module can receive as an input (input signal): driving speed and/or accelerator position and/or activity signal of an ESP control (ESP—Electronic Stability Control®) and/or ABS-control (ABS—antilock system). As an output (output signal), e.g. a current rotational speed and/or rotational speed change of the no longer present internal combustion engine can be artificially generated.

It is to be noted that the conversion kit can be composed of one bus module or multiple bus modules alone in an embodiment. In other embodiments, one or more bus modules and at least one additional component can be a constituent of the conversion kit, e.g. the adapters mentioned later.

Here, the term “electric traction drive” can also be understood such that an electric energy storage (battery) is also encompassed.

The invention also includes developments, by which additional advantages arise.

A development of the conversion kit includes that the said processor circuit is configured to receive sensor signals from a sensor circuit of an accelerator of the motor vehicle for the signal conversion and to perform a conversion of the physical movement and orientation of the accelerator signaled by the sensor signals into electrical and/or digital signals for the electric traction drive. Hereby, it can be taken into account that a throttle valve or injection is no longer controlled by means of the accelerator. An association of accelerator position and/or accelerator movement with the signals for the electric traction drive can be effected by means of at least one characteristic line. By the selection of the respective characteristic line course, therein, a “response behavior” of the electric traction drive to an accelerator actuation can be set (e.g. “lively” or “inert”).

A development includes that the processor circuit is configured, for the signal conversion, to receive a gear selection signal, which signals an engaged reverse gear, from an existing transmission of the motor vehicle (hereto, a measurement circuit can be present there) and to limit a reversing speed.

The limitation can be effected to a maximum value in a range from 3 km/h to 20 km/h. This advantageously prevents that the acceleration capacity of the electric motor from the stop results in undesired fast reversing because a starting torque of the electric motor can be larger than that of the formerly present internal combustion engine.

A development includes that the processor circuit is configured, for the signal conversion, to convert acceleration commands of an automatic distance control and/or an automatic driving speed control (ACC—adaptive cruise control) of the motor vehicle, which are addressed to an engine control device of the internal combustion engine, into adjusting signals for the electric traction drive. Thus, the drive assistance functionality of an automatic distance control and/or of an automatic driving speed control can be maintained. The expert can ascertain, which acceleration commands of the ACC have to be converted, in test drives, e.g. by analyzing the signals in an existing bus system. Suitable adjusting signals can be set by the expert depending on a desired or preset drive behavior of the electric motor. Possible variants for a drive behavior result e.g. from a preset time constant and/or a preset dead time for a control behavior.

A development includes that the processor circuit is configured to detect a predetermined signal pattern of an emergency brake situation based on a respective signal of an accelerator sensor and/or a brake pedal sensor and/or a brake pressure signal of a hydraulic brake circuit and/or an automatic emergency brake (AEB-automatic emergency brake) and/or a distance radar, and in case of a detected emergency brake situation, to transmit a switching signal for switching and/or deactivating and/or reducing a drive torque of the electric traction drive. Signal patterns, which indicate an emergency brake situation, can be generated e.g. by means of test drives on a test ground. A signal pattern can be stored by signal data and/or a hidden Markov model and/or an artificial neural network. By reducing the drive torque, the advantage arises that an unnecessary additional thrust of the rotor of the electric motor is prevented. An automatic emergency brake assistant can signal the initiation of an automatic brake maneuver in situations, in which a critical accident risk (e.g. a fast reducing distance to an object) is recognized, by a binary input signal (binary yes/no). A switching signal as an output can signal: “release accelerator”, thus simulate releasing the accelerator. Herein, the rotor of the electric motor can also be actively braked, e.g. by a generator operation (recuperation) or by means of a brake operation.

A development includes that the processor circuit is configured to generate an artificial operating signal of the internal combustion engine, in particular an engine speed, by means of the restbus simulation depending on a current motor state of the electric motor, and to signal it to at least one existing control device of the motor vehicle and/or to simulate an operation of at least one missing and/or not present component, in particular a gasoline pump and/or an injection system and/or a catalyst (e.g. a lambda probe) and/or a mass airflow sensor. Implementations of restbus simulations are known from the prior art per se. In context of the conversion kit, it can be advantageously prevented that existing control devices generate errors if input values e.g. from or at the engine control device and/or a lambda probe are missing. An artificial operating signal can be generated by means of at least one characteristic line to generate operating signals, which correspond to the current drive state. They can be ascertained in that, in a test vehicle, signals are filtered out e.g. in the engine control device present there. Simulation calculations can also be performed in a laboratory to ascertain the characteristic lines. Additionally or alternatively to characteristic lines, a numerical vehicle model can also be operated as a constituent of the restbus simulation. The characteristic lines specific to vehicle model per existing component can be read in the E-CAN module per vehicle type to be reconstructed and thus be adequately configured. The logic of the E-CAN module thus is basically maintained and can be advantageously adapted to new vehicles with small effort without requiring a fundamental new development.

However, some control devices are required in cluster even if they do no longer fulfill an actual function without the internal combustion engine as it can be the case with the engine control device. Then, such a control device has to remain present at least by its signals despite of the conversion. Therefore, a development includes that the processor circuit is configured to transmit a simulated state signal of an engine control device to a theft protection of an existing control device. Thus, such mechanisms can further function as standard and the motor vehicle can further be serviced in brand workshops without e.g. the theft protection being initiated. Alternatively thereto, in a development, the processor circuit is configured to transmit to a control device of a device cluster provided for theft protection input signals expected by it in a predetermined normal operation. The expert can take, which input signals are expected in the normal operation (no theft is present), from the device specifications. Thus, either one keeps a control device operable in the motor vehicle upon conversion in that one simulates the required input signals such that the control device functions further in the theft protection cluster or one simulates the control device having become dispensable including theft protection component such that the theft protection further functions, but the control device can be removed.

A development includes that the processor circuit comprises a data interface for receiving a vehicle-individual software configuration file and is configured to configure and to operate the signal conversion and/or the restbus simulation in the motor vehicle depending on the software configuration file of the motor vehicle received via the data interface. Thus, vehicle-individual communication signals, which result due to the vehicle-own equipment, can be flexibly post-configured in the conversion. In particular, the software configuration file includes the so-called communication matrix with signal types and communication parameters of the at least one existing bus system. It can be read out e.g. from at least one existing control device or a control device disassembled in the conversion and/or be retrieved from the manufacturer of the motor vehicle.

A development includes that the processor circuit is configured to adjust a currently applied torque (meant is positive and negative) of the electric traction drive for a speed control for adjusting the driving speed with calculation of a current brake effect and/or recuperation power and to receive a respective actual value of a current torque and/or a current amperage of the electric traction drive and a respective value of a current driving speed and a rated speed as an input and to transmit a respective rated value of a new torque and/or a new rotational speed and/or a new amperage and/or a new brake power of the recuperation to the electric traction drive as an output. Thus, the speed control of an existing control device does not have to be reconfigured itself.

A development includes that the processor circuit is configured to receive a respective actual value of a detection of a preceding object and a current distance to a recognized object as an input for an automatic speed adaptation (ACC) and to transmit a respective rated value of a new torque and/or a new rotational speed and/or a new amperage and/or a new brake power of the recuperation to the electric traction drive as an output, wherein the output is in particular realized as an incremental control for the torque and/or the rotational speed and/or the amperage and/or the recuperation power. The actual values taken as a basis here can be received e.g. from an existing control device for environmental monitoring. By the incremental control, an outer control loop around the inner control loop of the electric traction drive itself arises. Hereby, the at least one bus module can lead the control of the inner control loop towards a final target value by stepwise or continuous tracking of the rated value of this inner control loop. This has advantages e.g. in setting the time constant for achieving the target value, thus the response behavior of the electric traction drive. Thus, it can be adapted to a response behavior of an internal combustion engine e.g. to avoid a jumpy drive behavior.

A development includes that the processor circuit is configured to transmit a speed signal to at least one acoustic signal sound generator (so-called parking beepers) for a parking assistance (in particular level 2 of the automation) for activating the respective signal sound generator and/or depending on a steering signal, which signals a current automated longitudinal guidance of the motor vehicle (accelerating and braking). At the level 2, the motor vehicle can automatically steer (transverse guidance) from the view of the driver, but the driver still has to accelerate and brake (longitudinal guidance). As an input, a respective signal of the start of the parking maneuver and a parking spot arrangement and/or parking spot size and a current driving speed (from at least one existing control device) and a current steering position of a steering wheel (sensor circuit and/or existing control device of the parking assistance) and a current position of a gear selector lever are received, and as an output during a started parking maneuver, a torque and/or a rotational speed of the electric traction drive are adjusted depending on the adapted steering position of the steering wheel. Thus, the parking maneuver is fully automatically implemented.

A development includes that the conversion kit includes at least one adapter plug for a respective bus terminal plug. This allows fast mounting/conversion for different vehicle variants. Preferably, the provision of plug contacts for avoiding “open” connections, which have arisen by the disassembly of electronic components of the internal combustion engine, is provided in the conversion kit.

A development includes that the processor circuit is configured to pass state signals of the electric traction drive via the at least one existing bus system to a connectivity module (e.g. a mobile radio module and/or WiFi radio module) of an external radio-based interconnection of the motor vehicle. Preferred state signals can be the state of charge, state of health, charging commands for initiating a charging operation due to charging disposition, a temperature. Advantageously, this allows connection of the bus module to a connectivity module/a connectivity unit for transferring the state and the possibility of remote control (charging/load management) e.g. from a server unit or from a mobile device. In particular, the processor circuit is configured to transmit the state signals via the connectivity module to a software application of an Internet server and/or a portable mobile device (so-called smart device, e.g. smartphone or Tablet PC or smart watch) and/or to a remote control server for a demand and response charging behavior (power control for charging power) for grid stabilization of a public electrical grid and/or for price-optimized charging and/or discharging.

A development includes that the processor circuit is configured to signal a state of charge and/or a residual range and/or a temperature and/or to replace state variables of the internal combustion engine no longer relevant, in particular oil pressure, rotational speed, tank filling level, with predetermined replacement signals for avoiding error messages at a human-machine-interface (HMI).

A development includes that the processor circuit is configured to perform a heating/ventilation control of an additional heater (instead of the waste heat of the now missing internal combustion engine) depending on an operation input of a driver and/or to control a previous air conditioning of the motor vehicle if the electric traction drive receives a charging current and/or a remote control command via a radio-based communication link. It can be effected by means of the already described connectivity function of a connectivity module via a server and/or a software application (so-called app). The additional heater can comprise e.g. at least one coiled filament for electrically heating (electric heating).

A development includes that the processor circuit is configured to transfer signals from the at least one new bus system and/or new control device for a diagnostic function via the at least one existing bus system to an OBD2 socket (OBD—On-Board Diagnosis). Thus, the converted motor vehicle can also be diagnosed in a workshop in known manner.

As a further aspect of the solution, the invention provides a motor vehicle with a purely electric traction drive, i.e. a traction drive without internal combustion engine. In the motor vehicle, at least two bus systems are connected via an embodiment of the conversion kit according to the invention. The bus systems are in particular at least one existing bus system and at least one new bus system in the sense explained above. The purely electric traction drive can comprise an electric synchronous machine and/or an asynchronous machine and/or a synchronous reluctance motor as the respective electric motor, to mention just examples. The traction drive can comprise one electric motor or multiple electric motors. The motor vehicle is preferably configured as a car, in particular as a passenger car or truck, or as a passenger bus or as a motorcycle.

As a further aspect of the solution, the invention provides a method for operating a motor vehicle subsequently converted to an electric traction drive. At least one bus module couples at least one existing bus system and/or existing control device of the motor vehicle on the one hand and at least one new bus system and/or new control device of the electric traction drive on the other hand, and hereto, a processor circuit of the at least one bus module receives signals from the at least one existing bus system and/or existing control device and/or new bus system and/or new control device, translates them by means of a predetermined signal conversion and passes the translated signals. Signals of at least one (deactivated and/or disassembled) non-present assembly of an internal combustion engine are artificially generated by means of a restbus simulation. Thus, they are signals, which describe a physical procedure missing in the motor vehicle, e.g. at a missing lambda probe. For converting, thus, the at least one electric motor can be coupled to the powertrain of the motor vehicle, e.g. to a flange of an existing transmission. The bus module then connects or couples the at least one existing bus system and/or existing control device to the subsequently installed at least one new bus system and/or new control device.

Developments of the method according to the invention, which comprise features, as they have already been described in context of the developments of the conversion kit according to the invention, also belong to the invention. For this reason, the corresponding developments of the method according to the invention are not again described here.

The processor circuit can comprise a data processing device or a processor device, which is configured to perform an embodiment of the method according to the invention. Hereto, the processor circuit can comprise at least one microprocessor and/or at least one microcontroller and/or at least one FPGA (Field Programmable Gate Array) and/or at least one DSP (Digital Signal Processor). Furthermore, the processor device can comprise a program code, which is configured, upon execution by the processor circuit, to perform the embodiment of the method according to the invention. The program code can be stored in a data memory of the processor circuit.

The invention also includes the combinations of the features of the described embodiments. Thus, the invention also includes realizations, which each comprise a combination of the features of multiple of the described embodiments if the embodiments have not been described as mutually exclusive.

In the following, embodiments of the invention are described. Hereto, the single FIGURE shows:

FIGURE a schematic representation of an embodiment of the motor vehicle according to the invention, in which a conversion kit can perform an embodiment of the method according to the invention.

The execution examples explained in the following are preferred embodiments of the invention. In the execution examples, the described components of the embodiments each represent individual features of the invention to be considered independently of each other, which also each develop the invention independently of each other. Therefore, the disclosure also is to include combinations of the features of the embodiments different from the illustrated ones. Furthermore, the described embodiments can also be supplemented by further ones of the already described features of the invention.

In the FIGURE, identical reference characters each denote functionally identical elements.

The FIGURE shows a motor vehicle 10, which can for example be a car. The motor vehicle 10 can comprise a purely electric traction drive 11, of which an electric motor 12, an energy storage 13 and power electronics 14 are exemplarily illustrated in the FIGURE. The traction drive 11 can be retrofitted in the motor vehicle 10, that is by a conversion of the motor vehicle 10, an internal combustion engine 15 can be disassembled or removed and the traction drive 11 can have been installed at the place thereof or instead. Together with the internal combustion engine 15, at least one assembly of the internal combustion engine 15 can have been removed. e.g. an alternator, an exhaust tract with catalyst, a heat exchanger for heating air. For operating the traction drive 11, at least one control device ECU can furthermore have been retrofitted in the motor vehicle 10, which is therefore referred to as new control device 16. The at least one new control device 16 can be connected to at least one also retrofitted communication bus, that is to at least one new bus system 17.

Already before the conversion, at least one control device ECU can have been installed or present as an existing control device 18 in the motor vehicle 10, which can have been connected and still be connected to at least one existing bus system 19, for example a CAN bus. The at least one existing bus system 19 can be connected to the at least one new bus system 17 via a respective bus coupler 20, for example a CAN connector CAN-Conn. Examples for existing bus systems and new bus systems are respectively CAN, Flexray, Ethernet, LIN.

In order that the existing control devices 18 and the new control devices 16 can exchange signals or communicate with each other, a bus module 21 can be provided in the motor vehicle 10, which can perform the coupling or translation between the existing control devices 18 on the one hand and the new control devices 16 on the other hand. Additionally or alternatively, a translation of bus signals (independently of source and/or addressee) between existing bus system and new bus system can be provided by a bus module 21.

The bus module 21 can be connected to the at least one new bus system 17. Furthermore, it is illustrated how a direct connection 22 between the bus module 21 on the one hand and at least one existing control device 18 on the other hand can be additionally provided, whereto a data cable, for example a coaxial cable, can for example be provided. A bus module 21 can also connect at least one existing bus system to at least one new bus system as a bus gateway (not illustrated).

Furthermore, the motor vehicle can comprise a connectivity module 23, which is accessible for the bus module 21 via for example an existing bus system 19, for a data exchange with at least one device extraneous to vehicle and/or external to vehicle.

The bus module 21 can be a constituent of a conversion kit 24, by means of which the signal communication or signal transfer or the coupling of the new control devices 16 to the existing control devices 18 and/or of the at least one new bus system 17 to the at least one existing bus system 19 is allowed to the effect that the operation can be further effected in the existing bus system 19 and the existing control devices 18 in the manner as if the internal combustion engine 15 would be further present in the motor vehicle 10, i.e. an adaptation to the electric traction drive 11 is not required for them. The signal conversion and/or a restbus simulation of at least one disassembled existing control device 18 for the internal combustion engine 15 can be performed by the bus module 21 of the conversion kit 24.

In addition, at least one of the new control devices 16 can also be provided as a constituent of the conversion kit 24, to contribute to or perform a part of the signal conversion and/or restbus simulation. Such a new control device 16 then also presents a further bus module of the conversion kit 24.

In the motor vehicle 10, the additional effort for conversion is reduced because the conversion effort is reduced by the signal conversion and the restbus simulation. After the one-time development of the at least one bus module 21, the conversion effort for each further reconstructed vehicle is greatly reduced. A reconstruction is allowed within few hours (less than one working day) and the mounting can be able to be relatively simply effected based on a detailed instruction. The bus module/E-CAN module has already provided the required plugs to be able to connect/plug the relevant bus systems (e.g. as connectors 20). In the installation, the busses of the bus systems 17, 19 are plugged to the bus module/E-CAN module and the software configuration is then imported as a software configuration file according to vehicle type. The adaptation of the conversion kit to new vehicle models can also be effected by slight adaptations to hardware (new bus types) and/or software (new configuration files). Servicing and checking plans can be created and preset to the supervising partner workshops.

The at least one bus module provides modular hardware and software components, which can be “docked” or connected to the existing interconnection architecture of the motor vehicle to be converted. The development of such a conversion kit can be a relatively high one-time effort, but which then only has to be adapted for each further vehicle architecture. The electric motor 12 is e.g. coupled to the powertrain and the bus module/E-CAN module connects the existing bus systems and existing control devices to the subsequently installed bus of at least one new bus system and to the new control devices. Signals are translated and passed comparable to a gateway and missing signals are generated in the form of a restbus simulation. Restbus simulation is advantageous to prevent that existing control devices generate errors if input values e.g. from or at the engine control device are missing. However, some control devices are required in cluster even if they do no longer fulfill an actual function (such as e.g. an engine control device of the disassembled internal combustion engine 15), to ensure that theft protection mechanisms further function as a standard and/or the motor vehicle 10 can further be serviced in brand workshops. The restbus simulation relates e.g. to the engine rotational speed of the internal combustion engine, which does no longer exist. The conversion of signals by signal conversion for example relates to accelerator commands/signals, which are required in acceleration commands of the ACC (adaptive cruise control).

The bus module/E-CAN module is adapted by the vehicle-individual software configuration file, such that it can fulfill the function. The differences between the vehicles are especially the different signal types and communication parameters (communication matrix), which are adjustable.

The bus module/E-CAN module preferably comprises all of the required inputs/outputs, and adapter plugs to the relevant series bus plugs are constructed/kept available as a required supplement, which allow fast mounting/conversion.

In addition, the bus module/E-CAN module preferably offers the passage of relevant signals to the optionally connected connectivity module 23, which is present for an external interconnection of the vehicle. Here, signals can e.g. be the state of charge, state of health, charging commands, charging locations, temperature, which can be utilized via a software app. In addition, a demand & response capability is provided for grid stabilization and price-optimized charging among other things.

The diagnosis and the import of the software can be effected via the regular OBD2 (Onboard Diagnosis) socket from the basic vehicle. Thereby, maintaining the standard diagnostic function via the OBD2 socket of the basic vehicle is allowed. Servicing and repair of the components of the basic vehicle can thus be effected by an OEM workshop (OEM-original equipment manufacturer), the diagnosis is effected via the normal workshop tools and the OBD2 socket. In addition, a remote update capability and remote diagnosis capability are provided.

Driver assistance systems and certain electronic vehicle options “specific to combustion engines” of the basic vehicle can thus be advantageously further used.

A particularly preferred embodiment of the conversion kit includes the following components.

A bus module as a standard module for connection of the bus systems and control devices, for translation of commands of various bus types. A bus module for generating vehicle-individual restbus simulation for maintaining the standard vehicle functions (e.g. in the area of driver assistance or theft protection). It can be the same or a different bus module. Preferably, a switching/deactivation of the drive is provided in case of an emergency brake situation (AEB).

Maintaining the driver assistance functions like cruise control, ACC (Adaptive Cruise Control), parking assistance is preferably effected in that the relevant input variables like sensor signals, state signals are processed and passed to the new electric drive as suitable output control signals

Preferably, there is the connection of a bus module to a connectivity module, for transferring the state and the possibility of the remote control (charging/load management) e.g. from a server unit or mobile device.

For a HMI, ensuring that error messages are not displayed to the driver and that the suitable information can be displayed on the human-machine interface HMI existing or newly to be installed (relevant: state of charge, residual range, temperature; no longer relevant oil pressure, rotational speed, tank filling level) is effected.

Further preferred aspects are:
Ensuring a heating/ventilation control of an additional heater (instead of the waste heat of the engine) and operability by the driver.
A previous air conditioning of the vehicle if the vehicle is connected to the charging current—in context of the connectivity function (server/app).
Providing plug contacts for avoiding “open” connections, which have arisen by the disassembly of electronic combustion engine components.

By the at least one bus module 21, at least one of the following signal conversions and restbus simulations can be realized:
Accelerator:
   conversion of the physical movement and orientation into electrical or digital signals
   conversion into uniform linearly feeling change of the torque of the electric motor,
   limitation of reversing speed, in particular upon use of original transmission
Cruise control/ACC:
   Adaptation of the currently applied torque (positive/negative) for adjusting the driving speed (involving brake effect and recuperation) (input: current torque/amperage, current speed, rated speed, output: new torque/rotational speed/amperage, new brake power)
   Automatic speed adaptation/ACC: as above, based on the distance to the preceding vehicle (input: recognized object yes/no and current distance, if object recognized, current torque/brake power; output: incremental control torque/amperage/brake power)
Automatic emergency brake assistant
   Initiation of an automatic braking maneuver in situations, in which a critical accident risk (fast reducing distance to an object) is recognized (input signal: binary yes/no, output: signaled accelerator position signals deceleration, reduce speed)
Parking assistance: (level 2)
   Parking beeper: speed signal required for activation
   Vehicle automatically steers, sometimes driver still has to accelerate and brake, sometimes the vehicle does it
      Manual: input: signal of the start of the parking maneuver; parking spot arrangement/size, current speed, current steering position, current position gear selector lever; output: permanently adapted steering position during parking maneuver
Ensuring vehicle function
   Engine control device: It has to be ensured that the engine control ECU further functions. Part of the component protection/cluster; thus, it has to be further in the vehicle and operable on the CAN bus. For preventing malfunctions and error messages, the required input signals have to be received or available at the engine control ECU; the E-CAN module has to generate the suitable signals and input them to the engine control device based on the drive situation. Input: speed, accelerator position, ESP/ABS control (ESP-Electronic Stability Control®, ABS-antilock system); output: current rotational speed and/or rotational speed change
   Restbus simulation of missing further components: simulate fuel pump/injection system, catalyst, mass airflow sensor, tank filling level, which are stringently required. Realizable by co-writing, which signals go into/out of the engine control device with present internal combustion engine, then gradually filtering out.

Overall, the examples show, how a motor vehicle can be converted to an electric traction drive in terms of signals.

1. An electronic conversion kit (24) for a motor vehicle (10), in which an internal combustion engine (15) is exchanged for an electric traction drive (11) with electric motor (12),
characterized in that
the conversion kit (24) includes at least one bus module (21), which is configured to couple at least one existing bus system (19) and/or existing control device (18) of the motor vehicle (10) on the one hand and at least one new bus system (17) and/or new control device (16) of the electric traction drive (11) on the other hand, and which hereto provides a processor circuit, which is configured to receive signals from the at least one existing bus system (19) and/or existing control device (18) and/or new bus system (17) and/or new control device (16), to translate them by means of a predetermined signal conversion and to pass the translated signals and/or to artificially generate signals of at least one assembly of an internal combustion engine (15) by means of a restbus simulation.

2. The conversion kit (24) according to claim 1, wherein the processor circuit is configured, for the signal conversion,
to receive sensor signals from a sensor circuit of an accelerator of the motor vehicle (10) and to perform a conversion of the physical movement and/or orientation of the accelerator signaled by the sensor signals into electrical and/or digital signals for the electric traction drive (11), and/or to receive a gear selection signal, which signals an engaged reverse gear, from an existing transmission of the motor vehicle (10) and to limit a reversing speed, and/or
to convert acceleration commands of an automatic distance control and/or of an automatic driving speed control of the motor vehicle (10), which are addressed to an engine control device of the internal combustion engine (15), into adjusting signals for the electric traction drive (11).

3. The conversion kit (24) according to any one of the preceding claims, wherein the processor circuit is configured to detect a predetermined signal pattern of an emergency brake situation based on a respective signal of an accelerator sensor and/or a brake pedal sensor and/or a brake pressure signal of a hydraulic brake circuit and/or an automatic emergency brake and/or a distance radar and to transmit a switching signal for switching and/or deactivating and/or reducing a drive torque of the electric traction drive (11) in case of a detected emergency brake situation.

4. The conversion kit (24) according to any one of the preceding claims, wherein the processor circuit is configured to generate an artificial operating signal of an internal combustion engine (15), in particular a signal of an engine rotational speed, by means of the restbus simulation depending on a current motor state of the electric motor (12), and to signal it to at least one existing control device (18) of the motor vehicle (10) and/or to simulate an operation of at least one component in particular missing in the motor vehicle, in particular of a fuel pump and/or an injection system and/or a catalyst and/or a mass airflow sensor.

5. The conversion kit (24) according to any one of the preceding claims, wherein the processor circuit is configured to transmit a simulated state signal of an engine control device to a theft protection of an existing control device (18) or to transmit, to a control device of a device cluster provided for theft protection, input signals expected by it in a predetermined normal operation.

6. The conversion kit (24) according to any one of the preceding claims, wherein the processor circuit comprises a data interface for receiving a vehicle-individual software configuration file and is configured to configure and/or to operate the signal conversion and/or the restbus simulation depending on the software configuration file of the motor vehicle (10) received via the data interface in the motor vehicle (10), wherein the software configuration file in particular includes a communication matrix with signal types and/or communication parameters of the at least one existing bus system (19) and/or the characteristic lines of the existing components.

7. The conversion kit (24) according to any one of the preceding claims, wherein the processor circuit is configured to adjust a currently applied torque of the electric traction drive (11) for adjusting the driving speed with calculation of a brake effect and/or recuperation power for a speed control, and herein to receive a respective actual value of a current torque and/or a current amperage of the electric traction drive (11) and a respective value of a current driving speed and a rated speed as an input, and
to transmit a respective rated value of a new torque and/or a new rotational speed and/or a new amperage and/or a new brake power of the recuperation as an output to the electric traction drive (11).

8. The conversion kit (24) according to any one of the preceding claims, wherein the processor circuit is configured to receive a respective actual value of a detection of a preceding object and a current distance to a recognized object as an input for an automatic speed adaptation, and to transmit a respective rated value of a new torque and/or a new rotational speed and/or a new amperage and/or a new brake power of the recuperation as an output to the electric traction drive (11), wherein the output is in particular realized as an incremental control for the torque and/or the rotational speed and/or the amperage and/or the recuperation power.

9. The conversion kit (24) according to any one of the preceding claims, wherein the processor circuit is configured, for a parking assistance,
to transmit a speed signal to at least one acoustic signal sound generator for activating the respective signal sound generator, and/or to receive a respective signal of the start of a parking maneuver and a parking sport arrangement and/or parking sport size and a current driving speed and a current steering position of a steering wheel and a current position of a gear selector lever as an input and to adjust a torque and/or a rotational speed of the electric traction drive (11) as an output during a started parking maneuver depending on the adapted steering position of the steering wheel.

10. The conversion kit (24) according to any one of the preceding claims, wherein the conversion kit (24) includes at least one adapter plug for a respective bus terminal plug.

11. The conversion kit (24) according to any one of the preceding claims, wherein the processor circuit is configured to pass state signals of the electric traction drive (11) via the at least one existing bus system (19) to a connectivity module (23) of an external radio-based interconnection of the motor vehicle (10), wherein the processor circuit is in particular configured to transmit the state signals via the connectivity module (23) to a software application of an Internet server and/or a portable mobile device and/or to a remote control server for a demand and response charging behavior for grid stabilization and/or for price-optimized charging/discharging.

12. The conversion kit (24) according to any one of the preceding claims, wherein the processor circuit is configured to signal a state of charge and/or a residual range and/or a temperature and/or to replace state variables of an internal combustion engine (15), in particular oil pressure, rotational speed, tank filling level, no longer relevant in particular after the conversion, with predetermined replacement signals for avoiding error messages at a human-machine interface, HMI.

13. The conversion kit (24) according to any one of the preceding claims, wherein the processor circuit is configured to perform a heating/ventilation control of an additional heater depending on an operating input of a driver and/or to control a previous air conditioning of the motor vehicle (10), if the electric traction drive (11) receives a charging current in particular from a charging station and/or a remote control command via a radio-based communication link.

14. The conversion kit (24) according to any one of the preceding claims, wherein the processor circuit is configured to transfer signals from the at least one new bus system (17) and/or new control device (16) via the at least one existing bus system (19) to an OBD2 socket for a diagnostic function.

15. A motor vehicle (10) with a purely electric traction drive (11), characterized in that at least two bus systems are connected via a conversion kit (24) according to any one of the preceding claims in the motor vehicle (10).

16. A method for operating a motor vehicle (10) subsequently converted to an electric traction drive (11),
characterized in that
at least one bus module (21) overall couples at least one existing bus system (19) and/or existing control device (18) of the motor vehicle (10) on the one hand and at least one new bus system (17) and/or new control device (16) of the electric traction drive (11) on the other hand and hereto a processor circuit of the at least one bus module (21) receives signals from the at least one existing bus system (19) and/or existing control device (18) and/or new bus system (17) and/or new control device (16), translates them by means of a predetermined signal conversion and passes them and/or artificially generates missing signals of at least one assembly of an internal combustion engine (15) by means of a restbus simulation.
